(19) United States
(12) Patent Application Publication
(10) Pub. No.: US 2012/0060518 A1
(43) Pub. Date: Mar. 15, 2012

(54) Cryopump and filter device

(75) Inventor: Hidekazu Tanaka, Tokyo (JP)

(73) Assignee: SUMITOMO HEAVY INDUSTRIES, LTD., Tokyo (JP)

(21) Appl. No.: 13/137,787

(22) Filed: Sep. 13, 2011

(30) Foreign Application Priority Data
Sep. 13, 2010 (JP) 2010-204874

(51) Int. Cl. F04B 37/08; F04B 39/16; B01D 8/00

(52) U.S. Cl. 62/55.5; 417/901; 62/285

(57) ABSTRACT

A cryopump includes: a cryopump housing arranged to define an inner space of the cryopump from an outer environment; an exhaust duct arranged to connect with the cryopump housing so as to exhaust fluid from the inner space of the cryopump to the outer environment; and a filter structure. The filter structure includes: a filter arranged to remove a foreign body from fluid exhausted through the exhaust duct; and a filter mounting member arranged to mount the filter to the exhaust duct, wherein at least a part of a bypass flow passage that diverts fluid from the filter is formed in the filter mounting member.

### BACKGROUND OF THE INVENTION

1. Field of the Invention

The present invention relates to a cryopump and a filter device to be used for a cryopump.

2. Description of the Related Art

A cryopump comprising a filter for exhausting gas is known. In such a cryopump, for example, a filter standpipe is mounted within a relief conduit of the cryopump. The relief conduit is jointed to a exhaust conduit so as to form a tee, and the exhaust conduit is jointed to a housing that forms a vacuum chamber. At the end of the relief conduit, a relief valve is mounted. The filter standpipe extends, from where it is mounted in a relief passage into an exhaust passage. The filter standpipe has an open rim positioned within the exhaust passage.

### SUMMARY OF THE INVENTION

A cryopump according to an aspect of the present invention includes: a cryopump housing arranged to define an inner space of the cryopump from an outer environment; an exhaust duct arranged to connect with the cryopump housing so as to exhaust fluid from the inner space of the cryopump to the outer environment; and a filter structure. The filter structure includes: a filter arranged to remove a foreign body from fluid exhausted through the exhaust duct; and a filter mounting member arranged to mount the filter to the exhaust duct, wherein at least a part of a bypass flow passage that diverts fluid from the filter is formed in the filter mounting member.

Another aspect of the present invention is a filter device. The filter device to be used in a release line for exhausting fluid from a cryopump to outer environment. The filter device includes: a filter arranged to remove a foreign body; and a filter supporter arranged to mount the filter to the release line, wherein at least a part of a bypass flow passage that diverts fluid from the filter is formed in the filter supporter.

### BRIEF DESCRIPTION OF THE DRAWINGS

FIG. 1 schematically shows a cryopump according to an exemplary embodiment of the present invention;

FIG. 2 shows an example of a filter structure mounted to a duct according to an exemplary embodiment of the present invention;

FIG. 3 shows an example of a filter structure according to an exemplary embodiment of the present invention;

FIG. 4 shows an example of the filter structure according to an exemplary embodiment of the present invention; and

FIG. 5 shows an example of a filter structure according to an exemplary embodiment of the present invention.

### DETAILED DESCRIPTION OF THE INVENTION

The invention will now be described by reference to the preferred embodiments. This does not intend to limit the scope of the present invention, but to exemplify the invention.

The filter standpipe of the cryopump described above is a hollow cone-shaped screen and provided with an opening for a flowing gas when the screen is clogged with particles. Therefore, the filter standpipe needs to be extended so that the opening rim is positioned close to the exhaust flow passage in order to reduce particles flowing through the opening. Otherwise, the particles leaking and flowing through the opening to a release valve can not be caught sufficiently. In addition, a tee is needed to extend the filter standpipe into the exhaust flow passage. Thus, flexibility is limited in designing the structure or the arrangement of the filter and the mounting structure thereof.

It is desirable to provide a filter structure suitable to be mounted in a passage for exhausting fluid from a cryopump, and the cryopump provided with the filter structure.

According to an aspect of the present invention, a cryopump is provided. The cryopump includes: a cryopump housing arranged to define an inner space of the cryopump from an outer environment; an exhaust duct arranged to connect with the cryopump housing so as to exhaust fluid from the inner space of the cryopump to the outer environment; and a filter structure comprising: a filter arranged to remove a foreign body from fluid exhausted through the exhaust duct; and a filter mounting member arranged to mount the filter to the exhaust duct, wherein at least a part of a bypass flow passage that diverts fluid from the filter is formed in the filter mounting member.

According to this aspect, the filter structure mounted to the exhaust duct is provided with the bypass flow passage for diverting the flow of fluid from the filter. Therefore, fluid is exhausted through the filter under normal conditions and when the filter is clogged, the internal pressure can be released through the bypass flow passage. Thus, unpredictable increase in the internal pressure of the cryopump is restricted and the safety of the cryopump can be increased, accordingly. Further, by mounting the filter via the filter mounting member, a flexibility in the position where the filter is to be mounted, the way how to mount the filter, or the like can be increased. By forming at least part of the bypass flow passage in the filter mounting member, the bypass flow passage can be efficiently contained in a limited space in the exhaust duct.

The filter may have a bottomed shape provided with a bottom at a downstream side of the exhaust duct. An upstream side of the bottomed shape may be open. A concave inner-filter space may be formed inside the bottomed shape. The filter mounting member may include a conduit that leads a flow of fluid into the inner-filter space. A downstream end of the conduit may protrude into the inner-filter space, and a gap between the end of the conduit and an open end of the filter may form an inlet of the bypass flow passage. In this way, the flow of fluid in the direction reverse to a normal flow of fluid can be formed at an inlet of the bypass flow passage. Therefore, the flow of fluid that enters the bypass flow passage can be restricted or minimized when the filter functions effectively.

The filter structure may comprise a double-tube structure provided with an inner pipe that reduces a cross sectional area of a flow passage of an exhaust flow of fluid heading to the filter and an outer pipe that is formed outside of the inner pipe. The bypass flow passage may connect the inner pipe to the outer pipe. The bypass passage leads the flow of fluid from the inner pipe to the outer pipe, whereby the flow can be diverted to the outside of the filter. Thus, an opening for bypassing is not necessarily required to be provided directly in the filter. In addition, the structure having the inner pipe that reduces the cross sectional area of the flow passage heading to the filter is adopted, whereby the filter structure can be provided readily in an existing exhaust duct instead of replacing the exhaust duct with one with a large diameter.

The filter and the filter mounting member may be contained in the exhaust duct and may be arranged adjacent to each other along the direction of the flow of fluid. The bypass flow passage may include a main bypass passage arranged to allow fluid to flow in a direction along a cross sectional plane of the exhaust duct. The main bypass passage may be formed in the filter mounting member. By arranging the filter and the filter mounting member at offset positions along the direction of the flow of fluid, the proportion of an area occupied by the filter to the cross sectional area of the exhaust duct can be increased. By forming the main bypass passage in the filter mounting member along the in-plane direction, the main bypass passage can be designed to be comparatively large.

The bypass flow passage may comprise an inlet portion, a middle portion broader than the inlet portion, and an outlet portion narrower than the middle portion. Comparatively narrow inlet portion can restrict the flow of fluid entering the bypass flow passage when the filter functions effectively. Comparatively large middle portion can enlarge the effective opening cross sectional area of the bypass flow passage. Comparatively narrow outlet portion allows the bypass passage to be contained in a limited space in the exhaust duct.

The bypass flow passage may include a first gap arranged to allow fluid to flow in a direction reverse to that of the exhaust duct, and a second gap arranged to allow fluid that passes through the first gap to merge with a downstream flow from the filter. By providing the gaps, a normal flow passage flowing through the filter can be broadened.

The filter structure may comprise a center ring of a clamp-shaped joint. Thereby the filter structure can be applied readily to a clamp-shaped joint typically used for pipe arrangements of vacuum apparatuses. The replacement or the maintenance of the filter structure can also be performed easily.

The cryopump may further comprise a normally-closed type valve that is provided downstream from the filter structure in a flow direction of the exhaust duct and opens mechanically when being subject to a defined differential pressure with which an internal pressure of the cryopump housing is higher than an external pressure thereof. In this way, the valve can be functioned as a safety valve for releasing the inner pressure of the cryopump. Since the flow of fluid can be diverted from the filter, even when the filter upstream from the valve is clogged, the inner pressure of the cryopump is assured to work on the safety valve. Therefore, the safety of the cryopump can be increased.

Another aspect of the present invention is a filter device. The filter device is to be used in a release line for exhausting fluid from a cryopump to outer environment comprising: a filter arranged to remove a foreign body; and a filter supporter arranged to mount the filter to the release line, wherein at least a part of a bypass flow passage that diverts fluid from the filter is formed in the filter supporter.

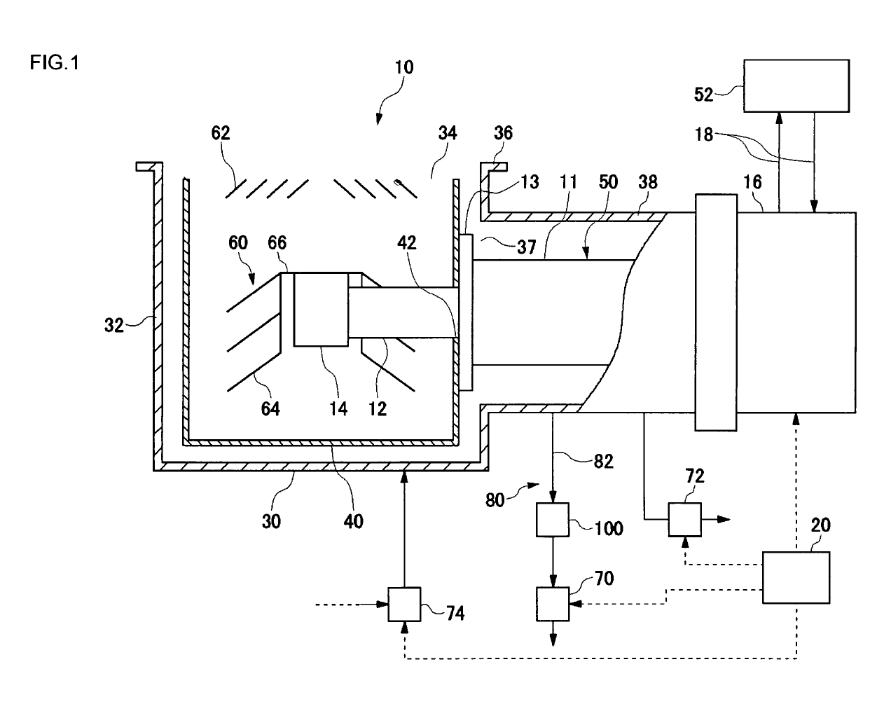

FIG. 1 schematically shows a cryopump 10 according to an exemplary embodiment of the present invention. The cryopump 10 is mounted to a vacuum chamber of an apparatus, such as an ion implantation apparatus, a sputtering apparatus, or the like that requires a high vacuum environment. The cryopump 10 is used to enhance the degree of vacuum in the vacuum chamber to a level required in a desired process. The cryopump 10 is arranged to include a cryopump housing 30, a radiation shield 40, and a refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12. The second cooling stage 14 is installed on the second cylinder 12 at the end that is farthest from the first cylinder 11. The refrigerator 50 illustrated in FIG. 1 is a two-stage refrigerator in which a lower temperature is attained by combining two cylinders in series. The refrigerator 50 is connected to a compressor 52 through a refrigerant pipe 18.

The compressor 52 compresses a refrigerant gas (i.e., an operating gas) such as helium or the like, and supplies the gas to the refrigerator 50 through the refrigerant pipe 18. While cooling the operating gas by allowing the gas to pass through a regenerator, the refrigerator 50 further cools the gas by expanding the gas in an expansion chamber inside the first cylinder 11 and in an expansion chamber in the second cylinder 12. Regenerators are installed inside the expansion chambers. Thereby, the first cooling stage 13 installed on the first cylinder 11 is cooled to a first cooling temperature level while the second cooling stage 14 installed on the second cylinder 12 is cooled to a second cooling temperature level lower than the first cooling temperature level. For example, the first cooling stage 13 is cooled to about 65-100 K while the second cooling stage 14 is about 10-20 K.

The operating gas, which has absorbed heat by expanding in the respective expansion chambers sequentially and cooled respective cooling stages, passes through the regenerator again and is returned to the compressor 52 through the refrigerant pipe 18. The flow of the operating gas from the compressor 52 to the refrigerator 50 and from the refrigerator 50 to the compressor 52 is switched by a rotary valve (not shown) in the refrigerator 50. A valve drive motor 16 rotates the rotary valve by supplying power from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor (not shown) may be provided on the first cooling stage 13 or the second cooling stage 14. The control unit 20 may control the cooling temperature by controlling the driving frequency of the valve drive motor 16. For this purpose, the control unit 20 may comprise an inverter for controlling the valve drive motor 16. The control unit 20 may be arranged so as to control the compressor 52, and respective valves that will be described later. The control unit 20 may be integrated with the cryopump 10 or arranged as a control device separate from the cryopump 10.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually orthogonally) with the axis of the cylindrical radiation shield 40. The present invention is also applicable to a so-called vertical-type cryopump in a similar way. In the vertical-type cryopump, the refrigerator is inserted along the axis of the radiation shield.

The cryopump housing 30 has a portion 32 formed into a cylindrical shape (hereinafter, referred to as a “trunk portion 32”), one end of which being provided with an opening and the other end being closed. The opening is provide as an inlet 34 through which a gas to be evacuated from the vacuum chamber of the sputtering apparatus or the like enters. The inlet 34 is defined by the interior surface of the upper end of the trunk portion 32 of the cryopump housing 30. On the trunk portion 32 also is formed an opening 37 for inserting the refrigerator 50. One end of a cylindrically-shaped refrigerator container 38 is fitted to the opening 37 in the trunk portion 32 while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted to the vacuum chamber, the content of which to be evacuated, of the sputtering apparatus or the like by using the mounting flange 36.

The cryopump housing 30 is provided in order to separate the inside of the cryopump 10 from the outside thereof. As described above, the cryopump housing 30 is arranged to include the trunk portion 32 and the refrigerator container 38, and the trunk portion 32 and the refrigerator container 38 are airtight and the respective insides thereof are maintained at a common pressure. The exterior surface of the cryopump housing 30 is exposed to the environment outside the cryopump 10 during the operation of the cryopump 10, i.e., even during operation of the refrigerator. Therefore the exterior surface is maintained at a temperature higher than that of the radiation shield 40. The temperature of the cryopump housing 30 is typically maintained at an ambient temperature. Herein, the ambient temperature refers to a temperature of a place where the cryopump 10 is installed or a temperature close to the temperature. The ambient temperature may be, for example, at or around room temperature.

A control valve 70, a rough valve 72 and a purge valve 74 are connected to the cryopump housing 30. The control valve 70, the rough valve 72, and the purge valve 74 are controlled by the control unit 20, respectively. Further, a pressure sensor for monitoring the internal pressure of the cryopump housing 30 may be provided (not shown).

The control valve 70 is provided, for example, at the end of a release line 80. Alternatively, the control valve 70 may be provided at the middle of the release line 80 and a tank or the like for collecting released fluid may be provided at the end of the release line 80. By allowing the control valve 70 to open, the flow of fluid at the release line 80 is permitted, and by allowing the control valve 70 to close, the flow of fluid at the release line 80 is blocked. Although the fluid to be exhausted is basically a gas, the fluid may be a liquid or a mixture of gas-liquid. For example, liquefied gas that is condensed by the cryopump 10 may be mixed with the fluid to be exhausted. By allowing the control valve 70 to open, the internal pressure of the cryopump housing 30 is released to the outside.

The release line 80 includes an exhaust duct 82 for releasing fluid from the internal space of the cryopump 10 to an exterior environment. The exhaust duct 82 is, for example, connected to the refrigerator container 38 of the cryopump housing 30. Although the exhaust duct 82 is a duct having a circular cross section orthogonal to the direction of the flow, the exhaust duct 82 may have a cross section of any other shapes. The release line 80 includes a filter structure 100 that includes a filter for removing foreign bodies from the fluid released through the exhaust duct 82. The filter structure 100 is provided upstream from the control valve 70 on the release line 80. According to an exemplary embodiment, the filter structure 100 is contained in the release line 80 completely and is arranged outside of the cryopump housing 30. The filter structure 100 is fitted to the release line 80 as a demountable structure.

The control valve 70 functions as a so-called safety cum vent valve. The control valve 70 is, for example, a normally-closed type electromagnetic on-off valve that is provided downstream from the filter structure 100 in the flow direction of the exhaust duct 82. The strength of a force required to close the control valve 70 is defined in advance so that the control valve 70 opens mechanically when being subject to a defined differential pressure, which is a predetermined high-pressure. The defined differential pressure can be set as appropriate by, for example, taking into consideration the internal pressure that can be exerted upon the cryopump housing 30, the structural durability of the cryopump housing 30, or the like. Since the external environment of the cryopump 10 is normally at an atmospheric pressure, the defined differential pressure is set to a proper high pressure with reference to the atmospheric pressure.

The control valve 70 is opened by the control unit 20 when fluid is released from the cryopump 10, for example, during the regeneration process. When fluid should not be released, the control valve 70 is closed by the control unit 20. In this way, the control valve 70 functions as a so-called vent valve. On the other hand, the control valve 70 is mechanically opened when the defined differential pressure is exerted thereon. As a result, when the internal pressure of the cryopump rises too high for some reasons, the control valve 70 is opened mechanically without requiring control. Combining the control valve 70 with a safety valve in this way leads to advantages of cost reduction and space saving in comparison with cases where two valves are separately provided.

According to an exemplary embodiment, a mechanical safety valve and a control valve as a so-called vent valve may be provided separately with the cryopump 10. In this case, as an alternative to the control valve 70, a mechanical safety valve may be provided on the release line 80 and the filter structure 100 may be provided upstream from the safety valve. In a similar way as with the rough valve 72 or the purge valve 74, the mechanical safety valve and the vent valve are connected to the cryopump housing 30 in parallel.

As will be described later, the filter structure 100 comprises a filter with a bypass. At least a part of the flow passage for diverting the flow of fluid from the filter is formed in a filter supporter for supporting the filter. For example, an alternate path may be formed in a mounting member for mounting the filter to the exhaust duct 82, or may be formed in a duct wall of the exhaust duct 82 at a position where the filter is mounted.

Foreign bodies moving with the exhaust flow and reaching to the control valve 70 are caught by the filter. This prevents the control valve 70 from biting foreign bodies when being opened or closed. Thereby, the sealing of the control valve 70 can be maintained satisfactory. On the other hand, by providing the alternate path, the continuity of the flow of fluid can be assured even if the filter is blocked by the accumulation of the foreign bodies. Thus, an excessive pressure rising inside the cryopump housing 30 can be prevented.

The rough valve 72 is connected to a roughing pump (vacuum pump), which is not shown in the figures. Opening or closing of the rough valve 72 opens the passage through between the roughing pump and the cryopump 10 or blocks the passage, respectively. The purge valve 74 is connected to a purge gas supply device (not shown). The purge gas is, for example, a nitrogen gas. The control unit 20 controls the purge valve 74, thereby the supply of the purge gas to the cryopump 10 is controlled.

The radiation shield 40 is arranged inside the cryopump housing 30. The radiation shield 40 is formed as a cylindrical shape, one end of which being provided with an opening and the other end being closed, that is, a cup-like shape. The radiation shield 40 may be formed as a one-piece cylinder as illustrated in FIG. 1. Alternatively, a plurality of parts may form a cylindrical shape as a whole. The plurality of parts may be arranged so as to have a gap between one another.

The trunk portion 32 of the cryopump housing 30 and the radiation shield 40 are both formed as substantially cylindrical shapes and are arranged concentrically. The inner diameter of the trunk portion 32 of the cryopump housing 30 is larger than the outer diameter of the radiation shield 40 to some extent. Therefore, the radiation shield 40 is arranged in the cryopump housing 30 without contact, spaced reasonably apart from the interior surface of the cryopump housing 30. That is, the outer surface of the radiation shield 40 faces the inner surface of the cryopump housing 30. The shapes of the trunk portion 32 of the cryopump housing 30 and the radiation shield 40 are not limited to cylindrical but may be tubes having a rectangular or elliptical cross section, or any other cross section. Typically, the shape of the radiation shield 40 is analogous to the shape of the interior surface of the trunk portion 32 of the cryopump housing 30.

The radiation shield 40 is provided as a shield to protect both the second cooling stage 14 and a low temperature cryopanel 60, which is thermally connected to the second cooling stage 14, from radiation heat mainly from the cryopump housing 30. The second cooling stage 14 is arranged inside the radiation shield 40, substantially on the central axis of the radiation shield 40. The radiation shield 40 is fixed to the first cooling stage 13 so as to be thermally connected to the stage, and the radiation shield 40 is cooled to a temperature comparable to that of the first cooling stage 13.

The low temperature cryopanel 60 includes, for example, a plurality of panels 64. Each of the panels 64 has a shape of the side surface of a truncated cone, i.e., an umbrella-like shape. Each panel 64 is attached to a panel mounting member 66 that is fixed to the second cooling stage 14. Typically, an adsorbent (not shown) such as activated carbon is provided on each panel 64. The adsorbent is adhered to, for example, the back face of the panel 64.

The panel mounting member 66 has a cylindrical shape, one end of which being closed and the other end being open. The closed end portion of the member is mounted at the upper end of the second cooling stage 14, and the cylindrical side surface of the member extends toward the bottom of the radiation shield 40 so as to surround the second cooling stage 14. The plurality of the panels 64 are attached to the cylindrical side surface of the panel mounting member 66 with spaces between one another. An opening for inserting the second cylinder 12 of the refrigerator 50 is formed on the cylindrical side surface of the panel mounting member 66.

A baffle 62 is provided in the inlet of the radiation shield 40 in order to protect both the second cooling stage 14 and the low temperature cryopanel 60, which is thermally connected to the stage, from radiation heat emitted from the vacuum chamber, etc. The baffle 62 is formed as, for example, a louver structure or a chevron structure. The baffle 62 may be formed as circular shapes concentrically arranged around the central axis of the radiation shield 40 or may be formed in another shape such as a lattice or the like. The baffle 62 is mounted at the opening end of the radiation shield 40 and cooled to a temperature comparable to that of the radiation shield 40. A gate valve (not shown) may be provided between the baffle 62 and the vacuum chamber. The gate valve is closed, for example, when the cryopump 10 is regenerated, and the gate valve is opened when the vacuum chamber is evacuated by the cryopump 10.

A refrigerator mounting opening 42 is formed on the side surface of the radiation shield 40. The refrigerator mounting opening 42 is formed on the side surface of the radiation shield 40 around the middle of the central axis of the radiation shield 40. The refrigerator mounting opening 42 of the radiation shield 40 is provided coaxially with the opening 37 of the cryopump housing 30. The second cylinder 12 and the second cooling stage 14 of the refrigerator 50 are inserted through the refrigerator mounting opening 42 in the direction perpendicular to the central axis of the radiation shield 40. The radiation shield 40 is fixed to the first cooling stage 13 so as to be thermally connected to the stage, at the refrigerator mounting opening 42.

As an alternative to the direct mounting of the radiation shield 40 to the first cooling stage 13, the radiation shield 40 may be mounted to the first cooling stage 13 by a connecting sleeve. The sleeve is, for example, a heat transfer member for surrounding one end of the second cylinder 12 at the first cooling stage 13 side and for thermally connecting the radiation shield 40 to the first cooling stage 13.

An explanation on the operations of the cryopump 10 with the aforementioned configuration will be given below. In operating the cryopump 10, the inside of the vacuum chamber is first roughly evacuated to approximately 1 Pa by another appropriate roughing pump through the rough valve 72 before starting the operation. Thereafter, the cryopump 10 is operated. By driving the refrigerator 50, the first cooling stage 13 and the second cooling stage 14 are cooled, thereby the radiation shield 40, the baffle 62, and the cryopanel 60, which are thermally connected to the stages, are also cooled.

The cooled baffle 62 cools the gas molecules flowing from the vacuum chamber into the cryopump 10 such that a gas whose vapor pressure is sufficiently low at the cooling temperature (e.g., water vapor or the like) will be condensed on the surface of the baffle 62 and exhausted, accordingly. A gas whose vapor pressure is not sufficiently low at the cooling temperature of the baffle 62 enters into the radiation shield 40 through the baffle 62. Of the entering gas molecules, a gas whose vapor pressure is sufficiently low at the cooling temperature of the cryopanel 60 will be condensed on the surface of the cryopanel 60 and exhausted, accordingly. A gas whose vapor pressure is not sufficiently low at the cooling temperature (e.g., hydrogen or the like) is adsorbed by an adsorbent, which is adhered to the surface of the cryopanel 60 and cooled, and the gas is exhausted accordingly. In this way, the cryopump 10 can attain a desired degree of vacuum in the vacuum chamber.

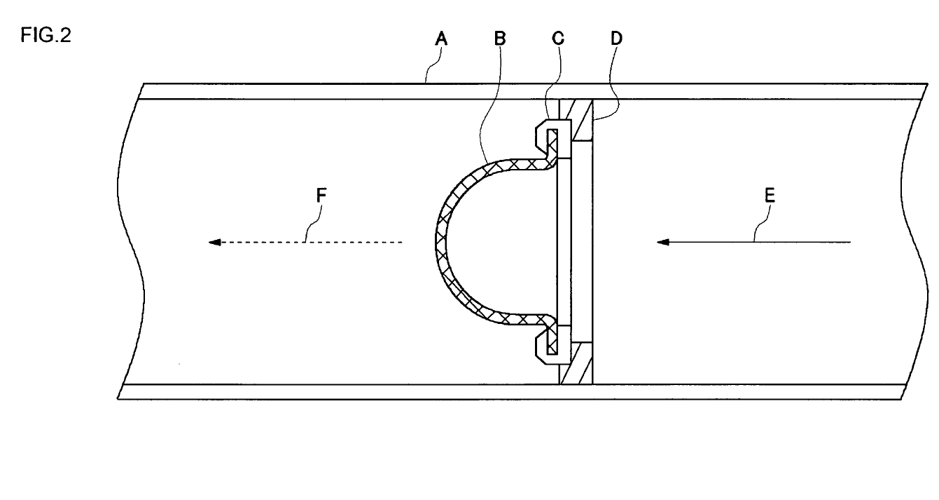

FIG. 2 shows an example of a filter B installed in a duct A. The filter B has a dome shape that protrudes downstream in the direction of the flow of fluid at the duct A (from right to left in FIG. 2). The upstream end of the filter B is supported by a circular rim C. At a position where the filter is to be mounted on the duct A, a circular supporter D that forms a bumped portion protruding from the inner surface of the duct to the inward of the duct in the radial direction is provided. On the circular portion of the circular supporter D, the circular rim C of the filter B is fitted and fixed. In this way, the filter B is mounted to the duct A. In this case, the upstream flow E (shown as a solid-line arrow) passes through the filter B to become the flow F (shown as a dashed-line arrow). Foreign bodies included in the flow E are removed from the flow F by the filter B. Accumulation of foreign bodies on the filter B will block the flow through the duct A.

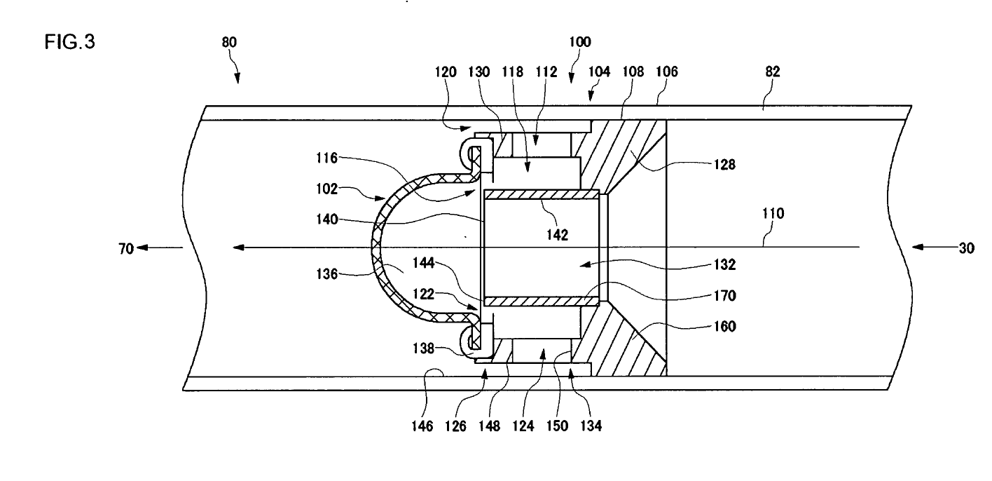

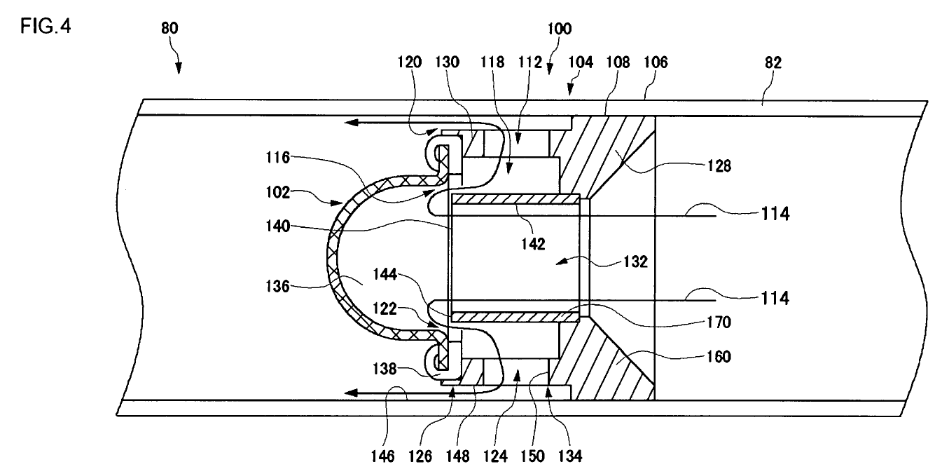

FIGS. 3 and 4 show a filter structure 100 according to an exemplary embodiment according to the present invention. FIG. 3 shows the flow of fluid at normal state and FIG. 4 shows the flow of fluid being diverted from the filter structure 100. The filter structure 100 is arranged to include a filter 102 and a filter supporter 104. The filter 102 catches foreign bodies included in the flow of fluid flowing from upstream to the filter 102. Thereby, the foreign bodies are removed from the downstream flow that has passed through the filter 102.

The filter supporter 104 supports the filter 102 on the release line 80 of the cryopump 10. The filter supporter 104 includes a mounting portion 106 on the exhaust duct 82 of the release line 80 and a filter mounting member 108 for mounting the filter 102 to the mounting portion 106.

The fluid passing through the release line 80 is typically a gas evaporated (e.g., through a regeneration process), which has been once condensed on the low temperature cryopanel 60. The foreign bodies are, for example, particles originated from the absorbent, such as activated carbon or the like being adhered on the cryopanel 60. The flow of fluid runs from the cryopump housing 30 to the control valve 70 through the exhaust duct 82, and exhausted from the cryopump 10 to the external environment, accordingly. At normal times when the filter 102 is not occluded by foreign bodies, the flow of fluid arises along the duct passage direction of the release line 80 as shown with the arrow 110. Hereinafter, this flow of fluid is also referred to as a “normal flow 110.” The normal flow 110 runs from a reducer 160 through an inside pipe 170 and enters into an inner-filter space 136. The normal flow 110 then runs from the inner-filter space 136 through the filter 102 to the downstream.

The filter 102 and the filter mounting member 108 are adjacent to each other in the exhaust duct 82 and the filter 102 is supported at the inside of the exhaust duct 82 by the filter mounting member 108. The filter mounting member 108 is arranged upstream from the filter 102. Alternatively, the filter mounting member 108 may be arranged downstream from the filter 102. The shape of the outer side surface of the filter mounting member 108 corresponds to the mounting portion 106 of the exhaust duct 82. In case the cross section of the exhaust duct 82 has a circular shape, the shape of the outer side surface of the corresponding filter mounting member 108 has also a substantially circular shape of the same radius. Therefore, the filter structure 100 can be readily applied to an existing exhaust duct 82. In order to form a bypass flow passage 112, the diameter of the duct does not need to be expanded, or a change of configuration such as a replacement of a duct with a large-radius duct is not required, thus the configuration described above is preferable.

A bypass flow passage 112 is formed in the filter supporter 104 or in the filter mounting member 108. The bypass flow passage 112 is a flow passage for permitting the flow of fluid that is diverted from the filter 102 when the filter 102 is occluded with foreign objects to some extent. Herein after, the flow of fluid runs through the bypass flow passage 112 is also referred to as a “bypass flow 114.”

As shown in FIG. 4, the bypass flow 114 runs into the inner-filter space 136 from the reducer 160 through the inside pipe 170. The passage of the flow of fluid is same as that of the normal flow 110 up to this point. When the bypass flow 114 arises, since the filter 102 is occluded, the flow runs from the inner-filter space 136 to the downstream through a first gap 122, through a main bypass passage 124, and through second gap 126 so as to be diverted from the filter 102.

By forming the bypass flow passage 112 in the filter supporter 104 or the filter mounting member 108, the filter 102 can occupy a larger cross sectional area of the exhaust duct 82. The flux of the normal flow 110 passing through the filter can be assured sufficiently. According to an exemplary embodiment, the filter 102 may be arranged so as to occupy the center portion of the exhaust duct 82, and the bypass flow passage 112 may be formed at the peripheral portion of the flow passage of the exhaust duct 82. According to an exemplary embodiment, the bypass flow passage 112 may include a curved flow passage or a maze structure in order to constrains the bypass flow 114 at a normal state.

The bypass flow passage 112 includes an inlet portion 116, a middle portion 118, and an outlet portion 120. The normal flow 110 branches to the bypass flow 114 at the inlet portion 116 and the bypass flow 114 merges with the normal flow 110 at the outlet portion 120. The inlet portion 116 and the outlet portion 120 are connected through the middle portion 118. The middle portion 118 has an opening cross sectional area larger than that of the inlet portion 116 and the outlet portion 120. Instead of maintaining the opening cross sectional area of the bypass flow passage at a constant size along the flow of fluid, the opening cross sectional area of the middle portion 118 is formed comparatively larger. Thereby, the effective opening cross sectional area of the bypass flow passage 112 can be readily designed to be a desirable size.

The opening cross sectional area of the bypass flow passage 112 is defined so that the cross sectional area of the bypass flow passage 112 is larger than the effective opening cross sectional area of the filter 102 when the filter is at a predetermined occlusion state. Thereby, the flow of fluid can be switched from the normal flow 110 to the bypass flow passage 112 when the filter 102 is clogged to an extent beyond the predetermined occlusion state.

The inlet portion 116 includes the first gap 122 for running the fluid in the direction reverse to the direction of the normal flow 110. That is, the flow at the first gap 122 includes a component in the direction reverse to the direction of the normal flow 110 and further may include a component in the radial direction of the exhaust duct 82 (i.e., a component along the surface that is orthogonal to the normal flow 110). By configuring the first gap 122 so that fluid flows in the reverse direction at the first gap 122, the bypass flow 114 can be minimized at a normal state.

The middle portion 118 includes the main bypass passage 124 formed in the filter mounting member 108. The flow passage cross sectional area of the main bypass passage 124 is larger than the first gap 122. Since the filter mounting member 108 is provided at an offset position from the position of the filter 102 in the direction of the flow of fluid, the cross sectional area of the main bypass passage 124 can be designed comparatively large. The main bypass passage 124 is formed so as to allow fluid to flow in a direction that intersects with the direction of the normal flow 110, that is, in a direction along the surface of a cross sectional plane of the exhaust duct 82. The main bypass passage 124 leads a fluid flowing from the first gap 122 to, for example, in a direction orthogonal to the normal flow 110 outwardly in a radial direction of the exhaust duct 82. By the first gap 122 and the main bypass passage 124, a first curved flow passage is formed. The first curved flow passage leads the flow of fluid to change directions from the direction reverse to the normal flow 110 to the outward radial direction of the exhaust duct 82.

The outlet portion 120 includes the second gap 126 for merging the flow of fluid with a flow of fluid downstream from the filter 102. The outlet portion 120 allows fluid to run in the direction of the normal flow 110. The flow of fluid at the second gap 126 includes a component in the direction same as that of the normal flow 110 and may further include a component in a radial direction of the exhaust duct 82. The cross sectional area of the flow passage of the second gap 126 is narrower than that of the main bypass passage 124. Fluid flowing from the main bypass passage 124 is led to the second gap 126. The main bypass passage 124 and the second gap 126 constitutes a second curved flow passage that leads the flow of fluid from the outward radial direction of the exhaust duct 82 in the direction of the normal flow 110. The narrow flow passages that allow fluid to run in the direction along the normal flow 110 are provided as the first gap 122 and the second gap 126, by which, the bypass flow passage 112 can be efficiently contained within the limited cross sectional area of the exhaust duct 82 and the normal flow passage flowing through the filter 102 can be broadened at the same time.

According to an exemplary embodiment, the bypass flow passage 112 is formed around the entire circumference of the exhaust duct 82. A plurality of bypass flow passages 112 may be formed discretely at a plurality of locations in a radial pattern. Alternatively, the bypass flow passage 112 may be formed radially discretely at one or a plurality of locations along the circumferential directions around the central axis of the exhaust duct 82.

The filter mounting member 108 includes a first portion 128 and a second portion 130. The filter mounting member 108 is installed in the exhaust duct 82 so that the first portion 128 is arranged upstream from the second portion 130. The first portion 128 is fixed to and integrated with the mounting portion 106 of the exhaust duct 82. The outer circumference of the second portion 130 has a smaller diameter than that of the first portion 128 to some extent. The second portion 130 forms a coaxial double tube structure in the exhaust duct 82. The bypass flow passage 112 is formed in the second portion 130.

The normal flow 110 is led to an inner duct 132 of the aforementioned double tube structure and the bypass flow 114 is led from the inner duct 132 to an outer duct 134. The inner duct 132 reduces the cross sectional area of the exhaust flow passage heading to the filter 102. The outer duct 134 is formed outside of the inner duct 132 and inside of the exhaust duct 82. The bypass flow passage 112 connects the inner duct 132 to the outer duct 134. The first portion 128 is fixed at the mounting portion 106, whereby in the outer duct 134 the flow of fluid heading downstream is allowed and the flow of fluid heading upstream is restricted. At the downstream end of the outer duct 134, the second gap 126 is formed.

The filter 102 has a bottomed shape having a bottom at the downstream side of the exhaust duct 82 and an opening at the upstream side thereof. For example, the filter 102 has a dome shape protruding in the downstream direction. In the bottomed shape of the filter 102, the inner-filter space 136 is formed. The filter 102 is, for example, a metal mesh. To the opening end of the filter 102, a base rim 138 that is a circular member for supporting the shape of the filter 102 is mounted. The filter 102 is mounted to the second portion 130 of the filter mounting member 108 via the base rim 138. The second portion 130 has a circular shaped mounting seat that corresponds to the base rim 138. In this way, the filter 102 is supported by the filter mounting member 108 coaxially with the central axis of the exhaust duct 82. The filter 102 may be a same filter as the general purpose filter B shown in FIG. 2, and an existing filter is applicable to the filter mounting member 108.

The filter mounting member 108 is arranged to include the so-called reducer 160 and the inside pipe 170. The reducer 160 includes the first portion 128 and the second portion 130. The diameter of the inner wall of the first portion 128 is continuously (or in a stepwise manner) reduced so as to lead the flow of fluid to the inside pipe 170. The inside pipe 170 is a conduit pipe for leading the flow of fluid to the inner-filter space 136. The inside pipe 170 is installed in the second portion 130 coaxially. The inner surface of the inside pipe 170 is an inner wall 142 that defines a main opening 140 for leading the flow of fluid into the inner-filter space 136. A sub bypass passage for leading the flow of fluid directly from the inside pipe 170 to the main bypass passage 124 may be formed in the inner wall 142. In this case, the bypass flow 114 has the flow of fluid that is diverted from the first gap 122.

By the inside pipe 170, triple flow passages are arranged in the second portion 130 of the reducer 160. The center portion, which is the inside of the inside pipe 170, is a flow passage that leads the flow of fluid from the reducer 160 to the inner-filter space 136. Between the inside pipe 170 and the second portion 130, a flow passage that connects through from the inlet portion of the bypass flow passage 112 to the main bypass passage 124 is formed. At the outside of the second portion 130, a flow passage that connects through from the main bypass passage 124 to the outlet portion of the bypass flow passage 112 is formed.

The filter mounting member 108 has the inner wall 142 that defines the main opening 140 for leading the flow of fluid into the inner-filter space 136. The first gap 122 between the opening end of the filter 102 and a downstream end 144 of the inner wall 142 forms the inlet of the bypass flow passage 112. The downstream end 144 of the inner wall 142 protrudes into the inner-filter space 136. The downstream end 144 of the inner wall 142 protrudes to the downstream side further than the upstream end surface of the base rim 138. The downstream end 144 of the inner wall 142 may protrude up to the metal mesh part of the filter 102. By such a protrusion, it is assured that the flow of fluid from the main opening 140 to the inner-filter space 136 in the direction reverse to the normal flow is generated in the first gap 122.

The filter mounting member 108 has an outer side wall 148 facing to the inner surface 146 of the exhaust duct 82 and the second gap 126 between the inner surface 146 and the outer side wall 148 forms the outlet of the bypass flow passage 112. The outer side wall 148 is a side surface of the second portion 130. A through hole 150 for connecting the inlet of the bypass flow passage 112 to the second gap 126 is formed in the outer side wall 148. The through hole 150 forms the main bypass passage 124. A plurality of through holes 150 are formed at a plurality of positions along the circumference of the second portion 130. For example, through holes 150 are formed at four positions, arranged every 90 degrees. In this way, the main bypass passage 124 is formed in the second portion 130 of the filter mounting member 108.

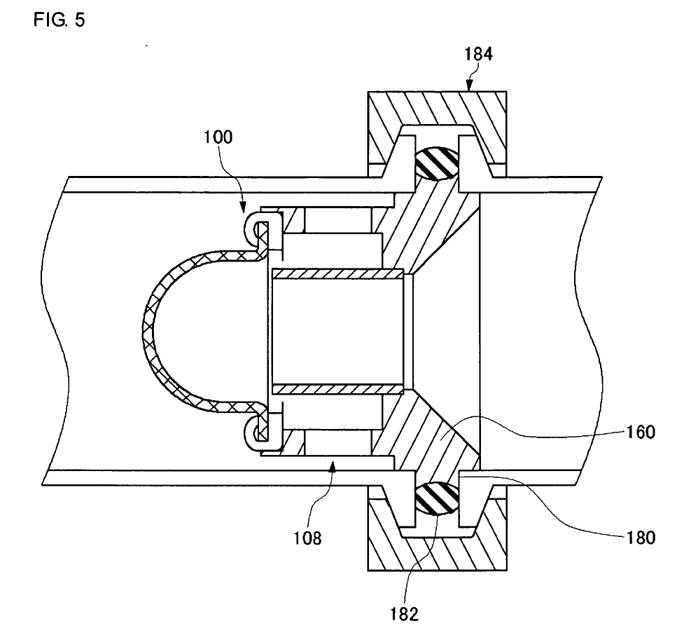

FIG. 5 shows an example of the filter structure 100 according to an exemplary embodiment of the present invention. The filter structure 100 has a similar structure as the one shown in FIG. 3 and FIG. 4 except that the filter structure 100 comprises a center ring of a clamp-shaped joint. In the filter structure 100 shown in FIG. 5, the upstream side of the filter mounting member 108 is formed as the center ring and the downstream side adjacent thereto is formed as a bypass flow passage.

More specifically, a guide unit 180 for an o-ring is formed as the center ring at the outer circumference of the reducer 160 of the filter mounting member 108. An o-ring 182 is attached to the guide unit 180 and the filter structure 100 is mounted to a commonly known clamp-shaped joint 184 as a demountable structure. By mounting the filter structure 100 to the clamp-shaped joint 184 that is commonly used for vacuum plumbing, a filter structure that allows easy replacement of a filter, easy maintenance, or the like, can be provided.

According to an exemplary embodiment of the present invention, the reducer 160 and the inside pipe 170 is arranged upstream from the filter 102 so as to lead a released gas to the center portion of the filter 102. The position of the outlet of the inside pipe 170 is protruded to the inner-filter space 136 surround by the filter 102, and a gap is formed between the filter 102 and the inside pipe 170. The bypass flow passage 112 of exhaust gas is located upstream from the outlet of the inside pipe 170.

Therefore, the exhaust gas is forced not to flow into the bypass flow passage 112 when the filter is not clogged. Foreign bodies are prevented from passing the bypass flow passage 112 and from outflowing downstream. When the filter is clogged, the exhaust gas passes through the gap between the inside pipe 170 and the filter 102 and flows into the bypass flow passage 112. Therefore, the release line 80 is not occluded. Since this prevent the increase of the internal pressure of the cryopump 10, the safety is further improved.

It should be understood that the invention is not limited to the above-described embodiment, but may be modified into various forms on the basis of the spirit of the invention. Additionally, the modifications are included in the scope of the invention.

Priority is claimed to Japanese Patent Application No. 2010-204874, filed Sep. 13, 2010, the entire content of which is incorporated herein by reference.

What is claimed is:

1. A cryopump comprising:
a cryopump housing arranged to define an inner space of the cryopump from an outer environment;
an exhaust duct arranged to connect with the cryopump housing so as to exhaust fluid from the inner space of the cryopump to the outer environment; and
a filter structure comprising: a filter arranged to remove a foreign body from fluid exhausted through the exhaust duct; and a filter mounting member arranged to mount the filter to the exhaust duct, wherein at least a part of a bypass flow passage that diverts fluid from the filter is formed in the filter mounting member.

2. The cryopump according to claim 1, wherein
the filter has a bottomed shape provided with a bottom at a downstream side of the exhaust duct, an upstream side of the bottomed shape being open, and a concave inner-filter space is formed inside the bottomed shape,
the filter mounting member includes a conduit that leads a flow of fluid into the inner-filter space, and
a downstream end of the conduit protrudes into the inner-filter space, and a gap between the end of the conduit and an open end of the filter forms an inlet of the bypass flow passage.

3. The cryopump according to claim 1, wherein the filter structure comprises a double-tube structure provided with an inner pipe that reduces a cross sectional area of a flow passage of an exhaust flow of fluid heading to the filter and an outer pipe that is formed outside of the inner pipe, and
the bypass flow passage connects the inner pipe to the outer pipe.

4. The cryopump according to claim 1, wherein
the filter and the filter mounting member are contained in the exhaust duct and are arranged adjacent to each other along the direction of the flow of fluid, and
the bypass flow passage includes a main bypass passage arranged to allow fluid to flow in a direction along a cross sectional plane of the exhaust duct, the main bypass passage being formed in the filter mounting member.

5. The cryopump according to claim 1, wherein the bypass flow passage comprises an inlet portion, a middle portion broader than the inlet portion, and an outlet portion narrower than the middle portion.

6. The cryopump according to claim 1, wherein the bypass flow passage includes a first gap arranged to allow fluid to flow in a direction reverse to that of the exhaust duct, and a second gap arranged to allow fluid that passes through the first gap to merge with a downstream flow from the filter.

7. The cryopump according to claim 1, wherein the filter structure comprises a center ring of a clamp-shaped joint.

8. The cryopump according to claim 1 further comprising a normally-closed type valve that is provided downstream from the filter structure in a flow direction of the exhaust duct and opens mechanically when being subject to a defined differential pressure with which an internal pressure of the cryopump housing is higher than an external pressure thereof.

9. A filter device to be used in a release line for exhausting fluid from a cryopump to outer environment comprising: a filter arranged to remove a foreign body; and a filter supporter arranged to mount the filter to the release line, wherein at least a part of a bypass flow passage that diverts fluid from the filter is formed in the filter supporter.
